(19) United States
(12) Patent Application Publication
(10) Pub. No.: US 2024/0380534 A1
(43) Pub. Date: Nov. 14, 2024

(54) BASE STATION, WIRELESS COMMUNICATION METHOD, AND WIRELESS COMMUNICATION SYSTEM

(71) Applicant: Panasonic Holdings Corporation, Kadoma-shi, Osaka (JP)

(72) Inventors: Yuzo MORIUCHI, Mie (JP); Rei HASEGAWA, Osaka (JP)

(21) Appl. No.: 18/566,131

(22) PCT Filed: Jun. 1, 2022
(86) PCT No.: PCT/JP2022/022401

§ 371 Date: Dec. 1, 2023

(30) Foreign Application Priority Data
Jun. 3, 2021 (JP) 2021-093740

(51) Int. Cl. H04L 5/00; H04B 7/024; H04B 7/06; H04W 64/00

(52) U.S. Cl. CPC H04L 5/0035; H04B 7/024; H04B 7/0617; H04W 64/006

(57) ABSTRACT

This base station is provided with: a control unit which performs inter-base station cooperative control on the basis of a regulations relating to cooperative control configured using spatial information relating to radio propagation in the space around the installation position of the base station; and a communication unit which transmits and receives signals to and from the terminal by means of control by the control unit.

### TECHNICAL FIELD

The present disclosure relates to a base station, a radio communication method, and a radio communication system.

### BACKGROUND ART

In a radio communication system such as a cellular network, an interference control technology has been studied.

For example, studies have been carried out on a technology in which a terminal reports a quality measurement result of a received signal to a base station and, based on the reported quality of the received signals, coordinated control between base stations is performed, thereby suppressing interference between cells.

### CITATION LIST

### Patent Literature

PTL: Japanese Patent Application Laid Open No. 2013-34053

### SUMMARY OF INVENTION

However, in coordinated control based on a quality measurement result, for example, due to a spatial condition between a terminal and a base station (hereinafter sometimes referred to as “between terminal-and-base station”), which is not necessarily reflected in the quality measurement result, a communication quality between terminal-and-base station may deteriorate. Accordingly, there is scope for further study on communication control that improves the communication quality between terminal-and-base station.

One non-limiting and exemplary embodiment of the present disclosure facilitates providing a base station, a radio communication method, and a radio communication system each capable of improving the communication quality between a terminal and a base station.

A base station according to an exemplary embodiment of the present disclosure includes: a controller, which in operation, controls communication to a terminal cooperating with another base station, based on information on a communication quality between the base station and the terminal and information on a spatial condition that possibly causes a fluctuation in radio wave propagation of a signal to be transmitted to the terminal; and a communicator, which in operation, communicates with the terminal under the control of the controller.

A radio communication method according to an exemplary embodiment of the present disclosure includes: controlling, by a base station, communication to a terminal cooperating with another base station, based on information on a communication quality between the base station and the terminal and information on a spatial condition that possibly causes a fluctuation in radio wave propagation of a signal to be transmitted to the terminal; and communicating, by the base station, with the terminal under the control of the controller.

A radio communication system according to an exemplary embodiment of the present disclosure includes: a first base station; a second base station; and a terminal, in which the first base station includes: a controller, which in operation, controls communication to the terminal cooperating with the second base station, based on information on a communication quality between the first base station and the terminal and information on a spatial condition that possibly causes a fluctuation in radio wave propagation of a signal to be transmitted to the terminal; and a communicator, which in operation, communicates with the terminal under the control of the controller.

It should be noted that general or specific embodiments may be implemented as a system, a method, an integrated circuit, a computer program, a storage medium, or any selective combination thereof.

According to an exemplary embodiment of the present disclosure, it is possible to improve the communication quality between a terminal and a base station.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates first examples of areas covered by two base stations;

FIG. 2A illustrates second examples of areas covered by the two base stations;

FIG. 2B illustrates third examples of areas covered by the two base stations;

FIG. 3A illustrates a first example of coordinated control in an embodiment;

FIG. 3B illustrates a second example of the coordinated control in the embodiment;

FIG. 4 illustrates a first configuration example of a radio communication system according to the embodiment;

FIG. 5 illustrates a second configuration example of the radio communication system according to the embodiment;

FIG. 6 illustrates a third configuration example of the radio communication system according to the embodiment;

FIG. 7 illustrates an arrangement example of the base stations;

FIG. 8 illustrates an example of arbitration area design of a case where spatial information is not used;

FIG. 9 illustrates a first example of area design of a case where the spatial information is used;

FIG. 10 illustrates a second example of the area design of a case where the spatial information is used;

FIG. 11 illustrates an example of arbitration judgement in the embodiment;

FIG. 12 is a sequence diagram indicating a flow of the arbitration judgement in the embodiment;

FIG. 13 is a flowchart indicating an example of determination of an arbitration condition; and

FIG. 14 illustrates a configuration example of a base station that uses the spatial information for location estimation.

### DESCRIPTION OF EMBODIMENTS

A preferred embodiment of the present disclosure will be described in detail with reference to the attached drawings. Note that elements having substantially the same functions are assigned the same reference numerals in the description and drawings to omit duplicated descriptions thereof.

### One Embodiment

### <Findings Leading to Present Disclosure>

For example, in a radio communication system, a base station forms an area (e.g., cell) for radio communication, and a terminal located in the area communicates with the base station by radio. In the radio communication system, areas formed by the respective base stations may partly overlap with each other. Signals from the plurality of base stations may arrive at an overlapping area. Studies have been carried out on controlling, through coordination between the base stations, communication between a base station and a terminal in such area (hereinafter sometimes referred to as “between base station-and-terminal”).

By way of example, when a base station forms a beam with directivity in a specific area of a cell and communicates with a terminal present in the area, areas covered by the beams formed by the base stations may overlap with each other. In communication with a terminal present in such area, a base station to communicate with the terminal and a beam used by the base station are determined between base stations. In the following, processing of determining a base station to communicate with a terminal and a beam used by the base station may be described as “arbitration.” An area at which signals transmitted using the beams of the base stations arrive may be referred to as an “arbitration target area.”

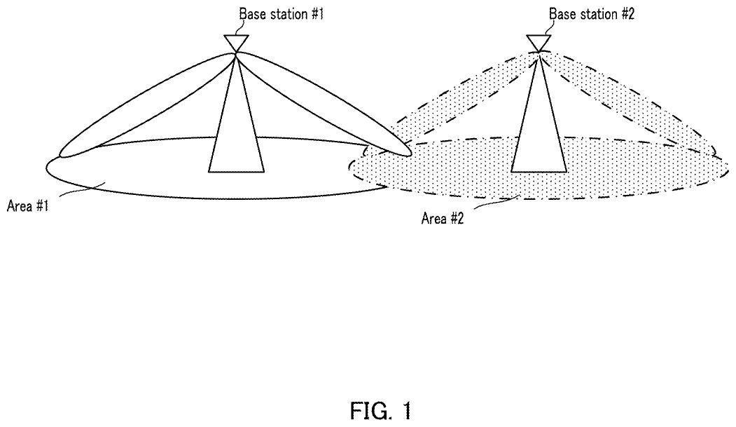

FIG. 1 illustrates first examples of areas covered by two base stations. In FIG. 1, base station #1 and base station #2 are illustrated.

In FIG. 1, area #1 covered by base station #1 and area #2 covered by base station #2 partly overlap with each other. When base station #1 and base station #2 each transmit signals to a terminal located in this overlapping area (e.g., arbitration target area), interference may occur in the terminal. Additionally, when base station #1 and base station #2 each receive a signal from the terminal located in the overlapping area, interference may occur in at least one of base station #1 and base station #2. Alternatively, when one of base station #1 and base station #2 transmits a signal to the terminal located in the overlapping area and the other of base station #1 and base station #2 receives a signal from the terminal located in the overlapping area, interference may occur in the base station and/or the terminal.

In coordinated control between base stations, a technology for avoiding interference can be applied when a plurality of base stations (or cells) transmits and receives signals.

For example, 3rd generation partnership project (3GPP) has discussed inter-cell interference avoidance technologies such as Inter-Cell Interference Coordination (ICIC), coordinated multipoint transmission (CoMP), eICIC, and eCoMP.

The CoMP includes, for example, technologies such as Coordinated Scheduling (CS) for performing scheduling in coordination between base stations, Coordinated Beamforming (CB) for performing beamforming in coordination between base stations, Dynamic Point Selection (DPS) for switching base stations (or beams of base stations) such that one base station with the best condition among a plurality of base stations communicates with a terminal, and Joint Transmission (JT) for performing transmission to one terminal by each of a plurality of base stations so as to increase a gain without causing mutual interference between the base stations.

For example, the interference avoidance technology is a technique to execute control for avoiding interference, based on information on a communication quality (communication quality information) between a base station and a terminal. The communication quality information may be measured by the terminal, and a measurement result may be fed back (or reported) from the terminal to the base station as the communication quality information, for example.

For example, in the CB, one base station is selected from a plurality of base stations based on the communication quality information, and a beam to be used by the selected base station for communication with a terminal is selected. Further, in the DPS, a base station to communicate with a terminal is selected from a plurality of base stations based on the communication quality information.

However, in the control based on the communication quality information, an appropriate control cannot be performed when accuracy of the communication quality information deteriorates, which may make it difficult to avoid interference.

Further, in the control based on the communication quality information, a determination result (e.g., selection result of base station) stochastically fluctuates with a stochastic fluctuation of a channel, which may make it difficult to avoid interference.

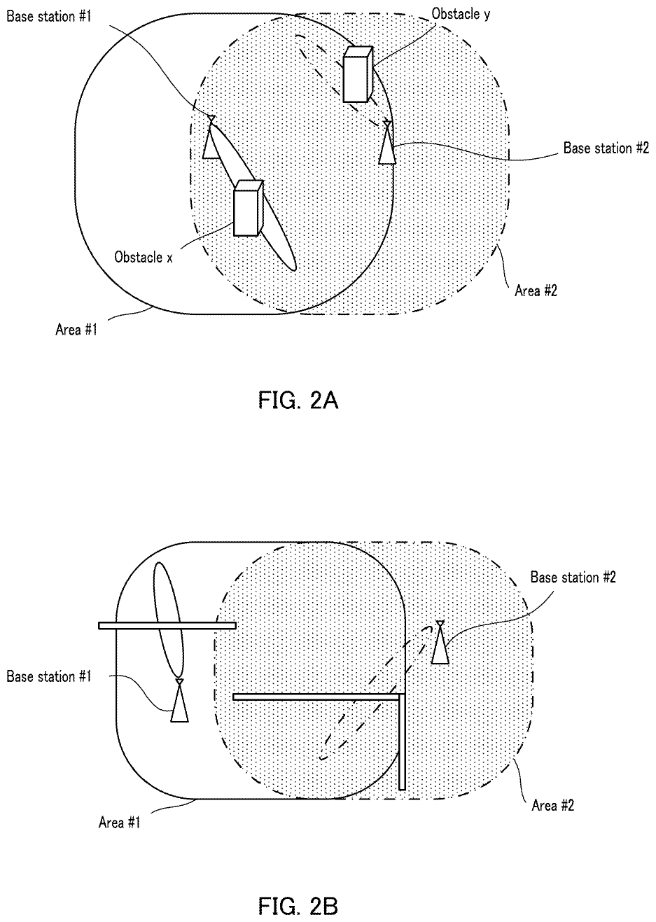

FIG. 2A illustrates second examples of areas covered by the two base stations. FIG. 2B illustrates third examples of areas covered by the two base stations. As with FIG. 1, FIG. 2A and FIG. 2B each illustrate area #1 covered by base station #1 and area #2 covered by base station #2.

For example, in FIG. 2A, the propagation characteristic deteriorates in an area which becomes out of line-of-sight (non-line of sight (NLOS)) from base station #1 due to an effect of obstacle x such as a building, and the propagation characteristic deteriorates in an area which becomes out of line-of-sight (non-line of sight (NLOS)) from base station #2 due to an effect of obstacle y. Also in FIG. 2B, the propagation characteristic deteriorates in each area which becomes NLOS from base station #1 and base station #2 due to an effect of wall-like obstacles.

In such cases, there is scope for further study on an arbitration method of determining how to execute coordinated control between two base stations.

In the present embodiment, an appropriate coordinated control is achieved using arbitration based on information on a space around a location at which a base station is provided (spatial information).

The spatial information is an example of information on a spatial condition that can cause a fluctuation in radio wave propagation of a signal transmitted by a base station to a terminal (or signal transmitted by terminal to base station). The spatial information includes spatial information on the radio wave propagation. In one example, the spatial information may include location information on an installation location of a base station, obstacle information on an obstacle present in the surroundings of the installation location of the base station and hindering the radio wave propagation, and information on an arbitration target area.

The spatial information may include a location relationship between the installation location at which the base station is provided and an object present around the installation location. Herein, the object may include a structure whose location is fixed (e.g., building, landform) and a moving object whose location is variable (e.g., vehicle, human). The spatial information may also include a fixed physical condition of the structure (e.g., relative permittivity, transmittance, and reflectance) and a physical condition of the moving object (e.g., vehicle, human). Further, the spatial information may include a physical condition of space that is a propagation medium around the installation location of the base station. For example, the physical condition of the space that is the propagation medium may be information on the weather (e.g., information on the presence or absence of rainfall or snowfall, fog, lightning, and temperature, and information on the amount of rainfall or snowfall).

The obstacle information may include information on a location, size, shape, and material of the obstacle. In addition, parameter information on radio wave propagation such as relative permittivity of the material forming the obstacle may be included.

There is no particular limitation on how to acquire the spatial information. For example, information on the structure whose location is fixed may be acquired from map information, landform information, or the like provided by an external server. Information on the moving object may be extracted through image processing from a video (image) taken by a camera for capturing an area around the base station or may be acquired from traffic information, global positioning system (GPS) information provided by an external server. By way of example, information on a congestion situation of vehicles may be acquired from the traffic information, or the amount of moving object may be estimated from image information from, e.g., the camera. The information on the weather may be acquired from weather information provided by an external server (e.g., weather forecasts) or may be extracted through image processing from a video (image) taken by a camera for capturing an area around the base station.

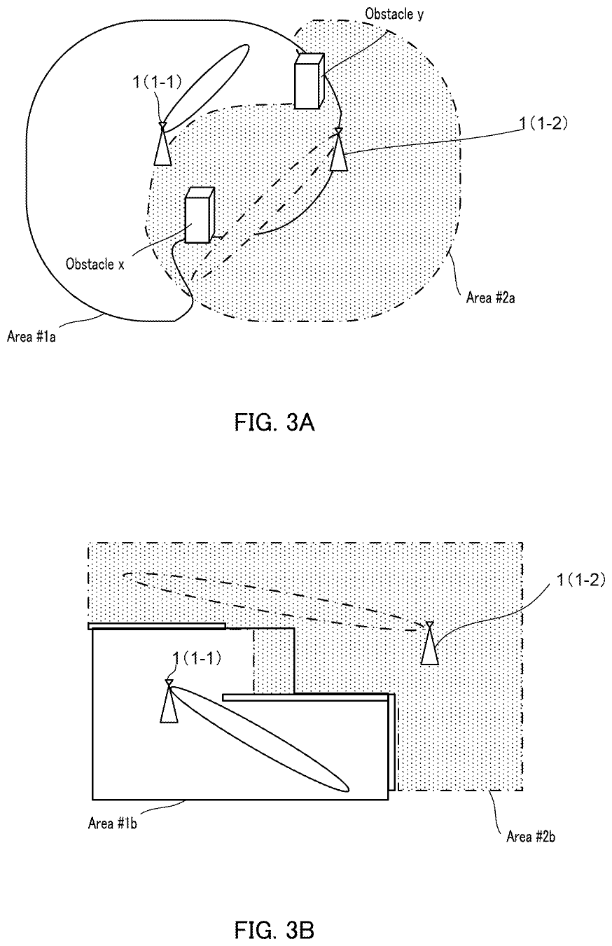

FIG. 3A illustrates a first example of coordinated control in the present embodiment. FIG. 3B illustrates a second example of the coordinated control in the present embodiment.

FIG. 3A illustrates examples of areas covered by two base stations when an appropriate coordinated control is executed in the example of FIG. 2A. FIG. 3A illustrates area #1a covered by base station 1-1 and area #2a covered by base station 1-2. FIG. 3B illustrates examples of areas covered by two base stations when an appropriate coordinated control is executed in the example of FIG. 2B. FIG. 3B illustrates area #1b covered by base station 1-1 and area #2b covered by base station 1-2.

The areas which become NLOS as viewed from base station #1 in FIG. 2A and FIG. 2B are turned into an area covered by base station 1-2 in FIG. 3A and FIG. 3B. Moreover, areas which become NLOS as viewed from base station #2 in FIG. 2A and FIG. 2B are turned into an area covered by base station 1-1 in FIG. 3A and FIG. 3B.

For example, in FIG. 2A, a terminal present in an NLOS location as viewed from base station #1 establishes a wireless connection with base station #1, which may cause deterioration of the communication quality of the terminal. On the other hand, in FIG. 3A, the arbitration based on the spatial information is used to allow a terminal present in an NLOS location as viewed from base station 1-1 to establish a wireless connection with base station 1-2 instead of base station 1-1, which can avoid deterioration of the communication quality of the terminal.

According to the present embodiment, an appropriate coverage area of a base station can be designed based on the spatial information, thus achieving the coordinated control by the arbitration between base stations.

For example, arbitration data is generated based on the spatial information. The arbitration data is, for example, data indicating an arbitration method between base stations or beams formed by the base stations. The arbitration data will be described later.

The arbitration data may be generated by an information processing apparatus prior to installation of a base station. Alternatively, the arbitration data may be generated by the information processing apparatus while a base station is installed and a base station is operating. A function to generate the arbitration data may be incorporated into a base station.

In the following, descriptions will be given of a configuration example in which the arbitration data is generated by an information processing apparatus prior to installation of a base station and is held in the base station (hereinafter referred to as first configuration example), a configuration example in which the arbitration data is generated by an information processing apparatus while a base station is installed and the base station is operating (hereinafter referred to as second configuration example), and a configuration example in which a function to generate the arbitration data is incorporated in a base station (hereinafter referred to as third configuration example).

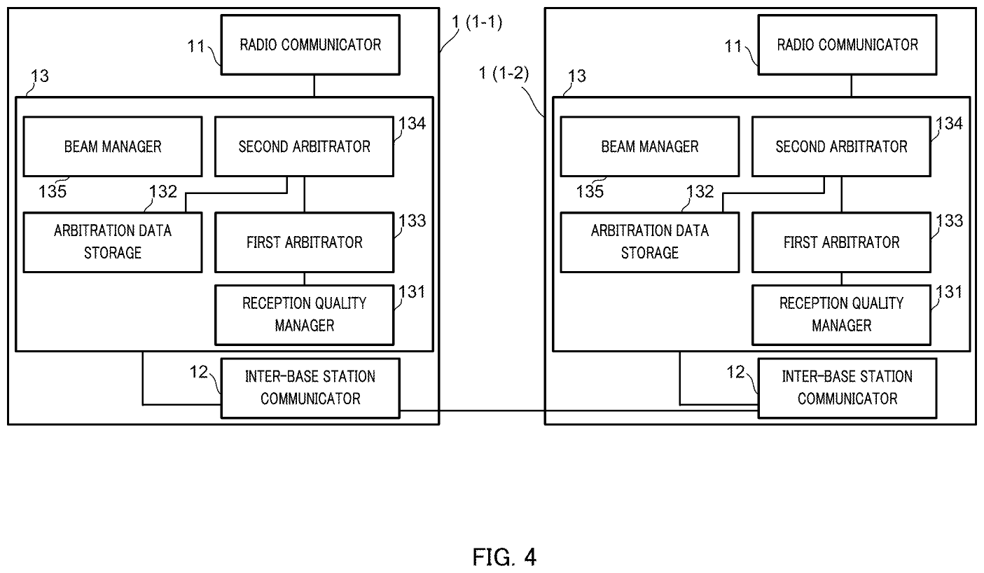

FIG. 4 illustrates a first configuration example of a radio communication system according to the present embodiment. In FIG. 4, two base stations 1-1 and 1-2 are illustrated. Base station 1-1 and base station 1-2 may have the same configuration. Hereinafter, a configuration example of base station 1-1 will be described.

Base station 1-1 includes radio communicator 11, inter-base station communicator 12, and controller 13.

Radio communicator 11 performs a radio communication with a terminal under the control of controller 13. For example, under the control of controller 13, radio communicator 11 forms a beam with directivity in a direction in which the terminal is located, transmits a signal to the terminal by using the formed beam, and receives a signal from the terminal.

Inter-base station communicator 12 is connected to another inter-base station communicator 12 of base station 1-2 (another base station) via an Xn interface. Base station communicator 12, for example, acquires inter-base station arbitration information from controller 13 and transmits the acquired inter-base station arbitration information to inter-base station communicator 12 of base station 1-2. Alternatively, base station communicator 12, for example, receives inter-base station arbitration information from inter-base station communicator 12 of base station 1-2 and outputs the received inter-base station arbitration information to controller 13.

Incidentally, although an example has been given in which inter-base station communicator 12 is connected via the Xn interface, the present disclosure is not limited to this example. Inter-base station communicator 12 may be connected to another inter-base station communicator 12 via an interface different from the Xn interface. Note that the connection between inter-base station communicators 12 may be a wired connection or a wireless connection. Further, inter-base station communicator 12 may be connected to two or more other inter-base station communicators 12. The connection among inter-base station communicators 12 may be a mixture of the wired connection and the wireless connection.

Controller 13 executes control of radio communication with a terminal. By way of example, when executing coordinated control with another base station in the radio communication with the terminal, controller 13 generates, transmits, and receives information for the inter-base station coordinated control.

Controller 13 includes reception quality manager 131, arbitration data storage 132, first arbitrator 133, second arbitrator 134, and beam manager 135.

Reception quality manager 131 manages a reception quality of a signal transmitted by a terminal and received by a base station (hereinafter referred to as Base Station (BS) reception quality) and a reception quality of a signal transmitted by the base station and received by the terminal (hereinafter referred to as Mobile Station (MS) reception quality). For example, reception quality manager 131 acquires, via radio communicator 11, a signal received by base station 1-1 and calculates a BS reception quality. Further, reception quality manager 131 causes base station 1-1 to transmit a signal for reception quality measurement (reference signal) to the terminal via radio communicator 11. Reception quality manager 131 then receives, from the terminal via radio communicator 11, a feedback signal including information on an MS reception quality and acquires the MS reception quality reported from the terminal. Reception quality manager 131 stores the calculated BS reception quality and the acquired MS reception quality.

The MS reception quality and/or the BS reception quality may be calculated for each beam formed by base station 1-1.

Arbitration data storage 132 stores arbitration data determined based on the spatial information (spatial information arbitration data). The arbitration data may be data calculated in advance by an external information processing apparatus or the like. Note that the arbitration data may be referred to as spatial information arbitration data or arbitration plan data.

First arbitrator 133 performs a first arbitration judgement based on the BS reception quality and/or the MS reception quality. First arbitrator 133 outputs a result of the first arbitration judgement to second arbitrator 134.

Second arbitrator 134 performs a second arbitration judgement based on the arbitration data and the result of the first arbitration judgement. Second arbitrator 134 outputs a result of the second arbitration judgement to beam manager 135.

Beam manager 135 controls a beam used by radio communicator 11, based on the result of the second arbitration judgement acquired from second arbitrator 134.

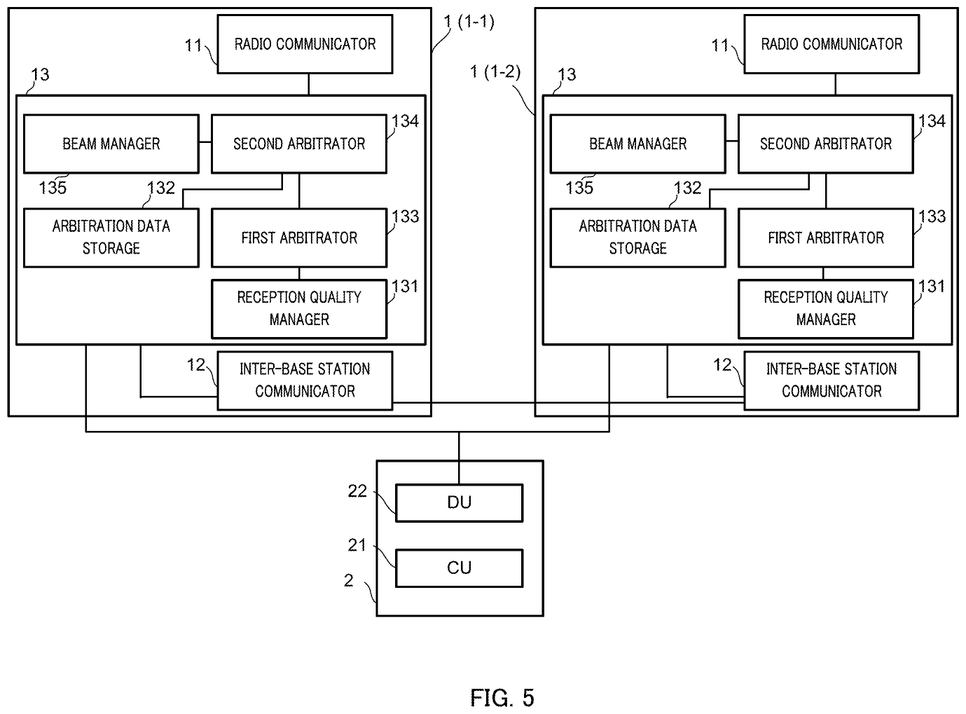

FIG. 5 illustrates a second configuration example of the radio communication system according to the present embodiment. Incidentally, in FIG. 5, the same configurations as in FIG. 4 are given the same reference numerals, and the descriptions thereof are omitted. In FIG. 5, two base stations 1-1 and 1-2 are illustrated. Base station 1-1 and base station 1-2 may have the same configuration.

A difference between FIG. 4 and FIG. 5 is that, in arbitration data storage 132 of FIG. 4, the previously generated arbitration data is stored, whereas, in arbitration data storage 132 of FIG. 5, arbitration data generated in core network 2 is stored and the arbitration data is sequentially updated by core network 2.

Core network 2 includes centralized unit (CU) 21 and distributed unit (DU) 22.

CU 21 acquires spatial information from an external apparatus and generates arbitration data. The spatial information includes, for example, information on an obstacle present in the surroundings of base station 1-1 and/or base station 1-2. The spatial information may also include information on radio wave propagation in the surroundings base station 1-1 and/or base station 1-2.

DU 22 transmits the arbitration data to arbitration data storages 132 of base station 1-1 and base station 1-2.

According to the second configuration example illustrated in FIG. 5, the arbitration data can be updated to follow a temporal fluctuation in the information affecting the radio wave propagation.

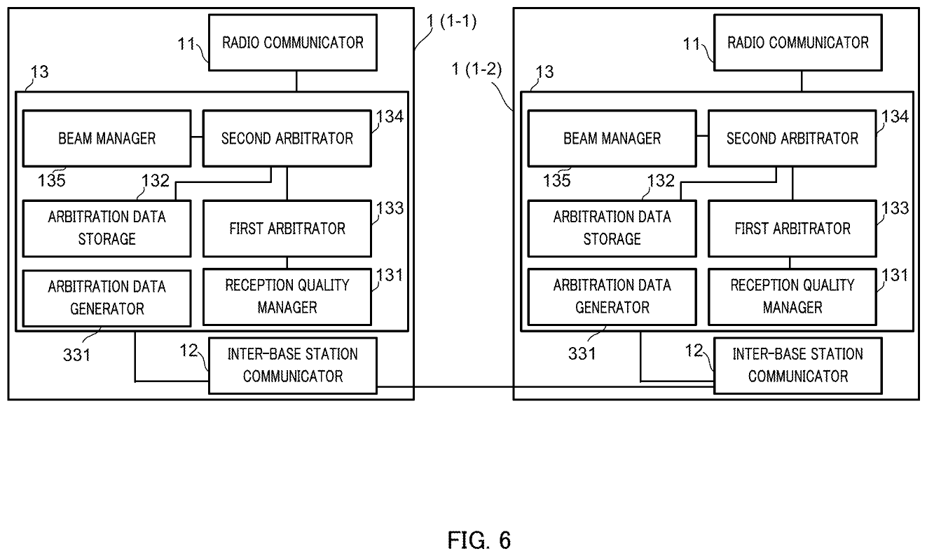

FIG. 6 illustrates a third configuration example of the radio communication system according to the present embodiment. Incidentally, in FIG. 6, the same configurations as in FIG. 4 are given the same reference numerals, and the descriptions thereof are omitted. In FIG. 6, two base stations 1-1 and 1-2 are illustrated. Base station 1-1 and base station 1-2 may have the same configuration. Hereinafter, a configuration example of base station 1-1 will be described.

FIG. 6 is different from FIG. 4 in that arbitration data generator 331 is added. In arbitration data storage 132 of FIG. 4, the previously generated arbitration data is stored, whereas, in arbitration data storage 132 of FIG. 6, arbitration data generated in arbitration data generator 331 is stored and the arbitration data is sequentially updated by arbitration data generator 331.

Arbitration data generator 331 acquires spatial information from an external apparatus and generates arbitration data. Arbitration data generator 331 outputs the arbitration data to arbitration data storage 132.

According to the third configuration example illustrated in FIG. 6, the arbitration data can be updated to follow a temporal fluctuation in the information affecting the radio wave propagation.

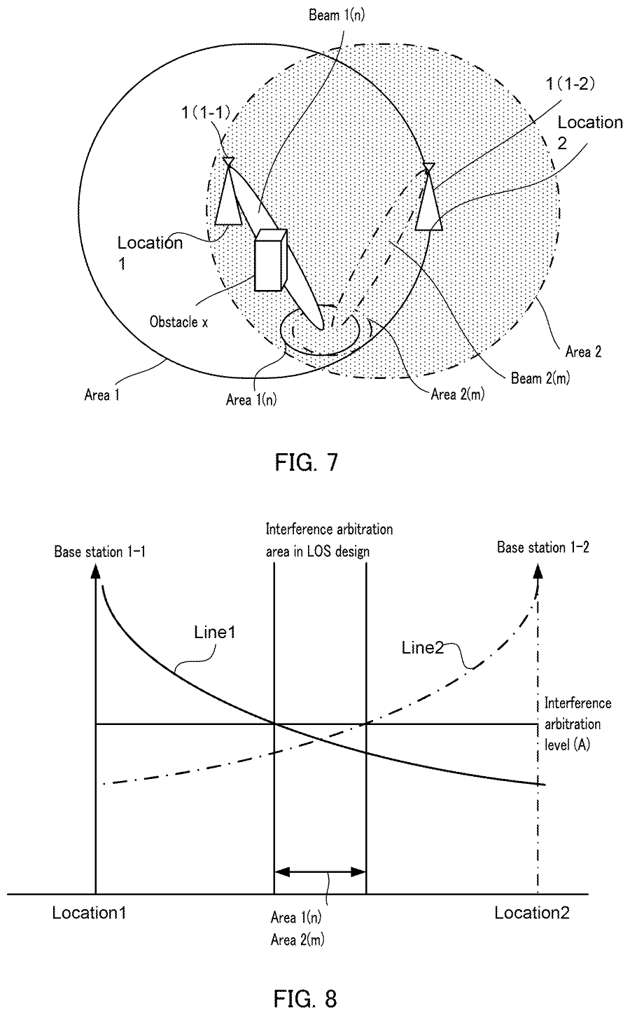

Next, a description will be given of an arbitration example based on the spatial information in the present embodiment. FIG. 7 illustrates an arrangement example of base stations.

An installation location of base station 1-1 is referred to as Location 1, and an installation location of base station 1-2 is referred to as Location 2. When the arbitration data is generated before the base stations are installed, the installation locations may be locations to be installed.

Base station 1-1 uses beam 1(n) to communicate with a terminal present in area 1(n). Incidentally, the letter, n, is an identifier for identifying a beam, and beam 1(n) indicates a beam corresponding to the identifier, n, of beams formed by base station 1-1. For example, in a case where base station 1-1 is capable of forming N beam(s) (N is integer greater than or equal to one), then the letter, n, is an integer from one to N, and base station 1-1 is capable of forming beam 1(1) to beam 1(N).

Base station 1-2 uses beam 2(m) to communicate with a terminal present in area 2(m). Incidentally, the letter, m, represents an identifier for identifying a beam, and beam 2(m) represents a beam corresponding to the identifier, m, of beams formed by base station 1-2. For example, in a case where base station 1-2 is capable of forming M beam(s) (M is integer greater than or equal to one), then the letter, m, is an integer from one to M, and base station 1-2 is capable of forming beam 2(1) to beam 2(M). Note that N and M may be the same or different to/from each other.

In FIG. 7, area 1(n) and area 2(m) overlap with each other. For example, this area corresponds to an arbitration target area. The arbitration may be performed for this area.

FIG. 8 illustrates an example of arbitration area design of a case where the spatial information is not used.

The horizontal axis of FIG. 8 indicates the distance. The term “Location 1” on the left of the horizontal axis corresponds to a location of base station 1-1, and the term “Location 2” on the right of the horizontal axis corresponds to a location of base station 1-2. The vertical axis of FIG. 8 indicates the power of a signal.

Line 1 of FIG. 8 indicates a relationship between a distance from base station 1-1 to a reception point (e.g., location of terminal) and a received power of a signal transmitted by base station 1-1 using beam 1(n). Line 2 of FIG. 8 indicates a relationship between a distance from base station 1-2 to a reception point (e.g., location of terminal) and a received power of a signal transmitted by base station 1-2 using beam 2(m). Each relationship between the distance and the received power illustrated in FIG. 8 is calculated assuming a line-of-sight (LOS) environment.

Further, in FIG. 8, an interference arbitration level is indicated. An area in which a calculated received power is equal to or less than the interference arbitration level corresponds to an interference arbitration area (e.g., arbitration target area where area 1(n) and area 2(m) overlap in FIG. 7).

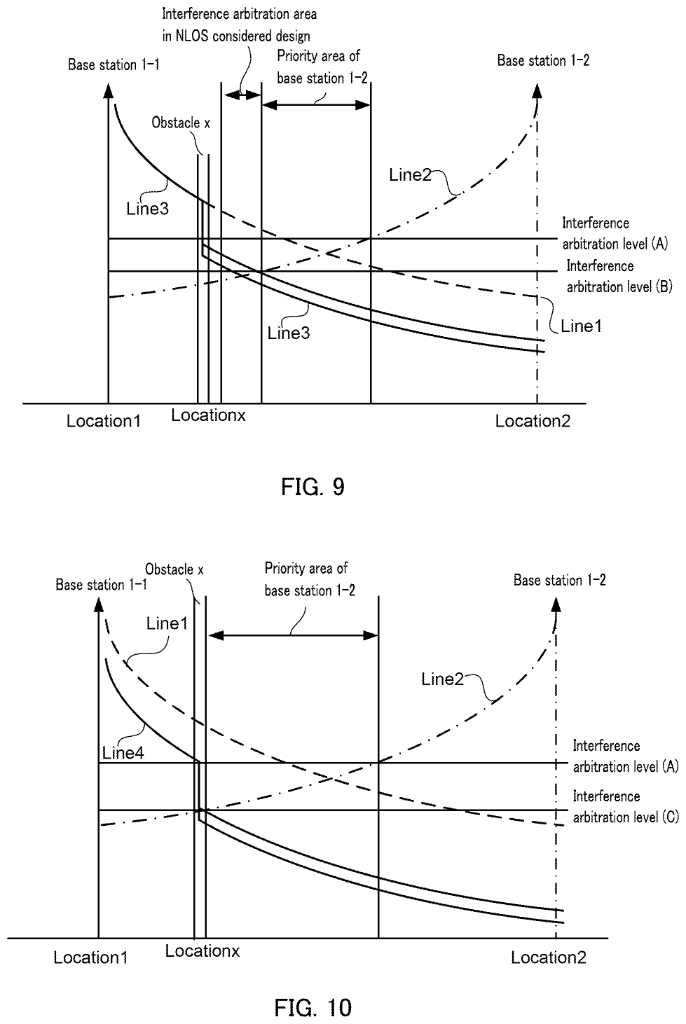

FIG. 9 illustrates a first example of area design of a case where the spatial information is used.

The horizontal axis of FIG. 9 indicates the distance. The term “Location 1” on the left of the horizontal axis corresponds to a location of base station 1-1, and the term “Location 2” on the right of the horizontal axis corresponds to a location of base station 1-2. The vertical axis of FIG. 9 indicates the power of a signal.

Line 3 of FIG. 9 indicates a relationship between a distance from base station 1-1 to a reception point (e.g., location of terminal) and a received power of a signal transmitted by base station 1-1 using beam 1(n). Line 2 of FIG. 9 indicates a relationship between a distance from base station 1-2 to a reception point (e.g., location of terminal) and a received power of a signal transmitted by base station 1-2 using beam 2(m). Each solid-line relationship between the distance and the received power illustrated in FIG. 9 is calculated assuming an NLOS environment as viewed from base station 1-1. Further, in FIG. 9, as in FIG. 8, Line 1 calculated assuming the LOS environment is indicated by a dashed line.

Line 3 of FIG. 9 indicates a relationship between a distance from base station 1-1 to a reception point and a received power, including power attenuation that occurs in obstacle x present at the location of “Location x.”

Further, in FIG. 9, since the NLOS environment is assumed, a value of the received power is unstable and, for example, delay spread is large as compared with the LOS environment. Therefore, the solid line (Line 3) of FIG. 9 has a width in the received power within a distance range to a location farther than “Location x” as viewed from the location of base station 1-1.

In the example of FIG. 9, interference arbitration level (B) lower than interference arbitration level (A) is configured. An area in which a calculated received power is equal to or less than interference arbitration level (B) corresponds to an interference arbitration area.

FIG. 8, which assumes the LOS environment without considering obstacle x, and FIG. 9, which assumes the NLOS environment considering obstacle x, are different from each other in a range of the interference arbitration area.

Specifically, the range belonging to the interference arbitration area in FIG. 8 is included in the area where base station 1-2 has priority in FIG. 9. Further, in FIG. 9, the interference arbitration area is shifted to a range away from base station 1-2, as compared with FIG. 8.

FIG. 10 illustrates a second example of area design of a case where the spatial information is used

The horizontal axis of FIG. 10 indicates the distance. The term “Location 1” on the left of the horizontal axis corresponds to a location of base station 1-1, and the term “Location 2” on the right of the horizontal axis corresponds to a location of base station 1-2. The vertical axis of FIG. 10 indicates the power of a signal.

Line 4 of FIG. 10 indicates a relationship between a distance from base station 1-1 to a reception point (e.g., location of terminal) and a received power of a signal transmitted by base station 1-1 using beam 1α(n). Line 2 of FIG. 10 indicates a relationship between a distance from base station 1-2 to a reception point (e.g., location of terminal) and a received power of a signal transmitted by base station 1-2 using beam 2(m). Each relationship between the distance and the received power illustrated in FIG. 10 is calculated assuming the NLOS environment. Further, in FIG. 10, as in FIG. 8, Line 1 calculated assuming the LOS environment is indicated by a dashed line.

In FIG. 10, base station 1-1 uses beam 1α(n), whereas base station 1-1 uses beam 1(n) in FIG. 9. Beam 1α(n) has directivity in the same direction as beam 1(n) and is formed with power less than that of beam 1(n)

Line 4 of FIG. 10 indicates a relationship between a distance and a received power, including power attenuation that occurs in obstacle x present at the location of “Location x.”

In the example of FIG. 10, interference arbitration level (C) lower than interference arbitration level (A) is configured. An area in which a calculated received power is equal to or less than interference arbitration level (C) corresponds to an interference arbitration area.

In FIG. 10, since beam 1α(n) having the less power than beam 1(n) is used, in the solid line of FIG. 10, a portion of a distance range to a location farther than “Location x” as viewed from the location of base station 1-1 corresponds to a priority area of base station 1-2. In other words, no interference arbitration area is configured in the distance range to the location farther than “Location x” as viewed from the location of base station 1-1.

In the manner described above, adjusting the interference arbitration level and/or the power of beam such that the range which becomes the NLOS environment as viewed from base station 1-1 corresponds to the priority area of base station 1-2 makes it possible to configure a range which becomes the NLOS environment as viewed from base station 1-1 as well as the LOS environment as viewed from another base station 1-2 as the priority area of base station 1-2 in the LOS environment, instead of the interference arbitration area.

Although FIG. 9 and FIG. 10 each illustrate a curved line indicating the relationship between a distance from a base station to a reception point (e.g., location of terminal) and a received power of a signal transmitted by the base station using a certain beam, the arbitration judgement using the spatial information may use a numerical value representing a prediction value of a propagation characteristic for a beam of the base station corresponding to an arbitration target area. In the following, a description will be given of an example of arbitration judgement based on a relationship among a path loss representing the propagation characteristic, NLOS, and a communication quality.

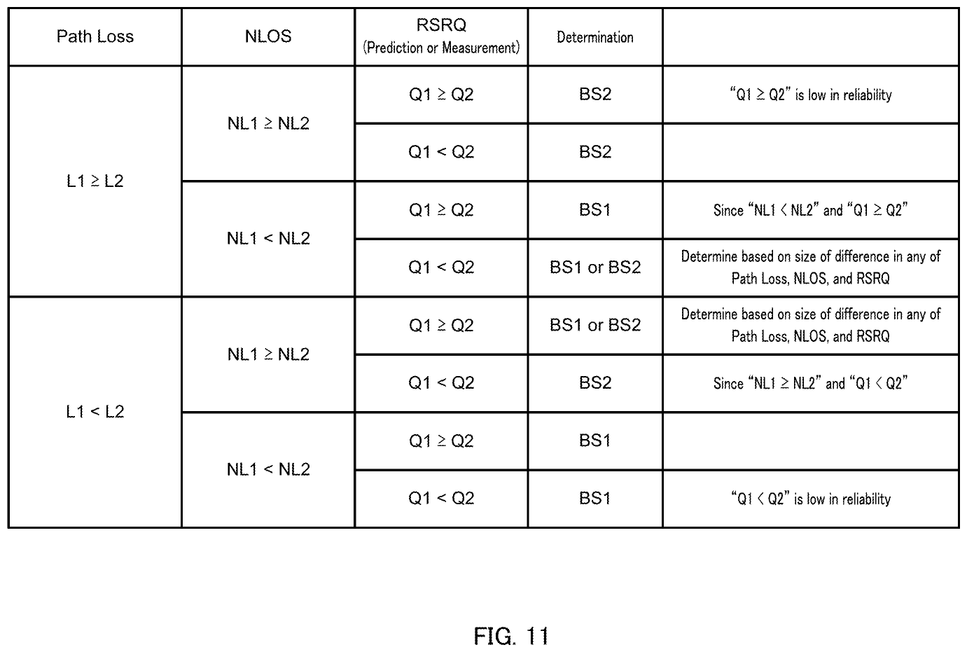

FIG. 11 illustrates an example of arbitration judgement in the present embodiment. FIG. 11 illustratively gives an example of arbitration judgement when an area where area 1(n) covered by beam 1(n) of base station 1-1 and area 2(m) covered by beam 2(m) of base station 1-2 overlap with each other is an arbitration target area. Note that the sign BS1 in FIG. 11 corresponds to base station 1-1, and the sign BS2 corresponds to base station 1-2.

The term Path Loss in FIG. 11 indicates a path loss calculated based on the spatial information.

The sign L1 indicates the size of path loss in area 1(n) when base station 1-1 transmits a signal using beam 1(n), and the sign L2 indicates the size of path loss in area 2(m) when base station 1-2 transmits a signal using beam 2(m). For example, the case of L1≥L2 is a case where the size of path loss for a signal transmitted by base station 1-1 using beam 1(n) is equal to or greater than the size of path loss for a signal transmitted by base station 1-2 using beam 2(m). The greater the path loss is, the worse the communication quality is, so that, in the case of L1≥L2, communication with base station 1-2 may be prioritized.

The term NLOS in FIG. 11 indicates the size of NLOS calculated based on the spatial information. For example, NLOS may be included in a portion of a path loss. In addition, NLOS may be, fading, multipath, delay spread, various clutter factors, and the like, which increase the uncertainty of communication quality.

The sign NL1 indicates the size of NLOS in area 1(n) when base station 1-1 transmits a signal using beam 1(n), and the sign NL2 indicates the size of NLOS in area 2(m) when base station 1-2 transmits a signal using beam 2(m). For example, the case of NL1≥NL2 is a case where the size of NLOS for a signal transmitted by base station 1-1 using beam 1(n) is equal to or greater than the size of NLOS for a signal transmitted by base station 1-2 using beam 2(m). The greater NLOS is, the worse the communication quality is, so that, in the case of NL1≥NL2, communication with base station 1-2 may be prioritized.

The path loss and NLOS are calculated with the spatial information. In FIG. 11, classification is made into four cases depending on a difference between a magnitude relationship of path losses and a magnitude relationship of NLOSs.

The term RSRQ (i.e., Reference Signal Received Quality) indicates a reception quality. For example, the sign Q1 indicates a reception quality measured by a terminal present in area 1(n) after receiving a signal transmitted by base station 1-1 using beam 1(n). The sign Q2 indicates a reception quality measured by a terminal present in area 2(m) after receiving a signal transmitted by base station 1-2 using beam 2(m).

Hereinafter, a description will be given of an example of arbitration judgement using the RSRQ in each of the four cases depending on the difference in the magnitude relationship of path losses and the magnitude relationship of NLOSs.

For example, in the case of L1≥L2 and NL1≥NL2, communication with a terminal is performed by base station 1-2 when Q1≥Q2, whereas, when Q1<Q2, the communication with the terminal is performed by base station 1-2. That is, in the case of L1≥L2 and NL1≥NL2, a quality of the communication between base station 1-1 and the terminal is likely to be worse than that of the communication between base station 1-2 and the terminal, under both conditions of a path loss and NLOS. Accordingly, in a reception quality report from the terminal, even when Q1≥Q2, arbitration based on the spatial information is performed without adopting arbitration based on the reported reception quality.

For example, in the case of L1≥L2 and NL1<NL2, communication with the terminal is performed by base station 1-1 when Q1≥Q2, whereas, when Q1<Q2, the communication with the terminal is performed by base station 1-1 or base station 1-2. In this case, since NL1<NL2 and Q1≥Q2 even when L1≥L2, the communication with the terminal is performed by base station 1-1. Further, for example, in the case of Q1<Q2, a base station to perform the communication with the terminal is selected based on at least one of the size of L1−L2, the size of NL1−NL2, and the size of Q1−Q2. By way of example, base station 1-2 may be selected when the size of L1−L2 is equal to or greater than a threshold and the size of NL1−NL2 is less than the threshold, base station 1-1 may selected when the size of L1−L2 is less than the threshold and the size of NL1−NL2 is equal to or greater than the threshold, and a base station may be selected at random when none of the conditions is satisfied.

For example, in the case of L1<L2 and NL1<NL2, communication with a terminal is performed by base station 1-1 when Q1<Q2, whereas, when Q1≥Q2, the communication with the terminal is performed by base station 1-1. That is, in the case of L1<L2 and NL1<NL2, a quality of the communication between base station 1-2 and the terminal is likely to be worse than that of the communication between base station 1-1 and the terminal, under both conditions of a path loss and NLOS. Accordingly, in a reception quality report from the terminal, even when Q1<Q2, arbitration based on the spatial information is performed without adopting arbitration based on the reported reception quality.

For example, in the case of L1<L2 and NL1≥NL2, communication with the terminal is performed by base station 1-2 when Q1<Q2, whereas, when Q1≥Q2, the communication with the terminal is performed by base station 1-1 or base station 1-2. In this case, since NL1≥NL2 and Q1<Q2 even when L1<L2, the communication with the terminal is performed by base station 1-2. Further, for example, in the case of Q1≥Q2, a base station to perform the communication with the terminal is selected based on at least one of the size of L1−L2, the size of NL1−NL2, and the size of Q1−Q2. By way of example, base station 1-2 may be selected when the size of L1−L2 is equal to or greater than a threshold and the size of NL1−NL2 is less than the threshold, base station 1-1 may selected when the size of L1−L2 is less than the threshold and the size of NL1−NL2 is equal to or greater than the threshold, and a base station may be selected at random when none of the conditions is satisfied.

Incidentally, although FIG. 11 illustrates an example including, in the arbitration between the two base stations, the four types of handling of the reception quality information depending on the magnitude relationship of two path losses and the magnitude relationship of two NLOSs, the present disclosure is not limited to this example. In one example, the difference between two path losses may be divided into three or more levels, and the difference between two NLOSs may be divided into three or more levels. In this situation, there may be nine types of handling the reception quality information, or quality information other than the RSRQ may be added to selection of an arbitration judgement condition.

Further, although FIG. 11 illustrates an example of the arbitration between beams of the two base stations (beam 1(n) of base station 1-1 and beam 2(m) of base station 1-2), the number of beams of base stations subject to the arbitration may be three or more. In this situation, since arbitration among total three beams is performed based on the spatial information, there may be path losses of three values and NLOSs of three values.

Further, although FIG. 11 illustrates an example in which the area covered by one beam of each of the two base stations is a target for the arbitration, the present disclosure is not limited to this example. In one example, the target for the arbitration may be an overlapping area of a case where an area covered by two beams, beam 1(n) and beam 1(p), formed by base station 1-1 and an area covered by two beams, beam 2(m) and beam 2(q), formed by base station 1-2 overlap with each other. In this situation, since arbitration among total four beams is performed, there may be path losses of four values and NLOSs of four values.

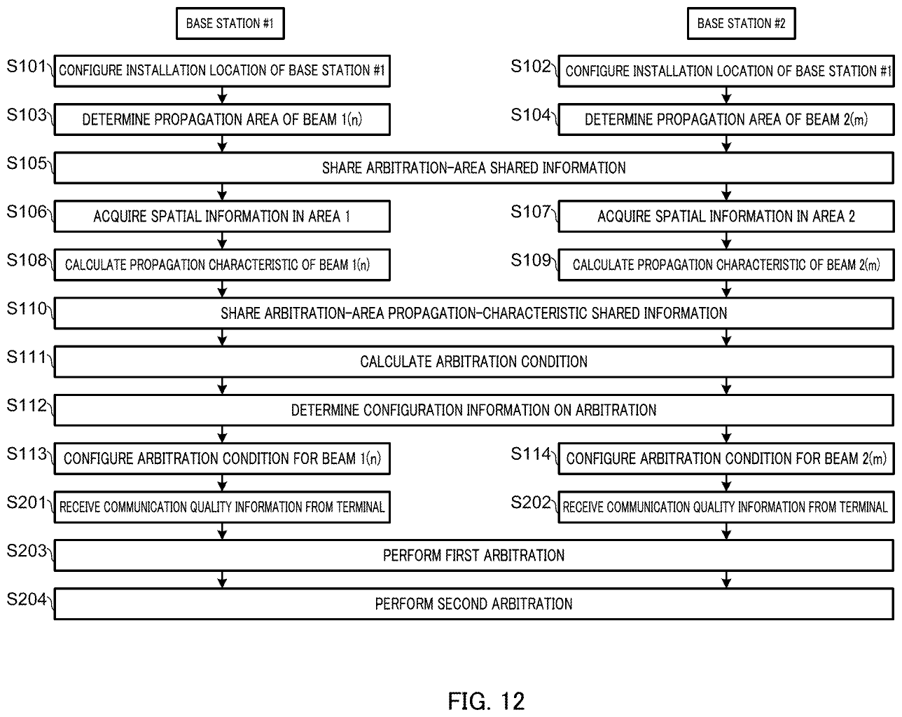

Next, a flow of arbitration judgement in the present embodiment will be described. FIG. 12 is a sequence diagram indicating a flow of the arbitration judgement in the present embodiment. The processing indicated in the sequence diagram illustrated in FIG. 12 may be performed, for example, prior to installation of base station 1-1 (described as base station #1 in FIG. 12) and base station 1-2 (described as base station #2 in FIG. 12) or after the installation of base stations 1-1 and 1-2.

An installation location of base station 1-1 is configured (S101). The location of base station 1-1 is described as Location 1.

An installation location of base station 1-2 is set (S102). The location of base station 1-2 is described as Location 2.

A propagation area of beam 1(n) is determined (S103). The propagation area of beam 1(n) corresponds to area 1(n). Incidentally, the letter, n, is from one to N. In S103, the propagation area is determined for each of the N beam(s).

A propagation area of beam 2(m) is determined (S104). The propagation area of beam 2(m) corresponds to area 2(m). Incidentally, the letter, m, is from one to M. In S104, the propagation area is determined for each of the M beam(s).

Information on the configured locations (Location 1 and Location 2) of the base stations and the propagation areas of the beams are shared between base station 1-1 and base station 1-2 (S105). Herein, the information to be shared may be described as arbitration-area shared information. For example, when the information on the propagation area of each of the base stations (e.g., area 1(1) to area 1(N) and area 2(1) to area 2(M)) is matched and then area 1(n) and area 2(m) overlap with each other, the overlapping area may be referred to as an arbitration area. Note that the arbitration area is not limited to one (one pair).

Base station 1-1 then acquires spatial information in area 1 (S106). Base station 1-2 acquires spatial information in area 2 (S107).

Next, base station 1-1 calculates a propagation characteristic of beam 1 (n) based on the acquired spatial information (S108). The propagation characteristic may be calculated for each of the N beam(s). Alternatively, of the N beam(s), a propagation characteristic of beam 1(n) that forms the arbitration area may be calculated.

Base station 1-2 calculates a propagation characteristic of beam 2(m) based on the acquired spatial information (S109). The propagation characteristic may be calculated for each of the M beam(s). Alternatively, of the M beam(s), a propagation characteristic of beam 2(m) that forms the arbitration area may be calculated.

The calculated propagation characteristic are shared between base station 1-1 and base station 1-2 (S110). Herein, the information to be shared may be described as arbitration-area propagation-characteristic shared information.

An arbitration condition is determined based on the arbitration-area propagation-characteristic shared information (S111). Note that this processing may be performed by either base station 1-1 or base station 1-2 and shared between the base stations. The arbitration condition may correspond to a rule of the arbitration judgement based on the reception quality. Further, the processing of S111 will be described later.

Configuration information on the arbitration for each base station is determined and indicated (S112). For example, the configuration information on the arbitration may include a setting for a rule of the arbitration judgement based on the reception quality. Incidentally, this processing may be performed by either base station 1-1 or base station 1-2.

Base station 1-1 configures an arbitration condition for beam 1(n) (S113). Base station 1-2 configures an arbitration condition for beam 2(m) (S114).

A series of processing of S101 to S114 mentioned above may be performed once or multiple times after base station 1-1 and base station 1-2 are installed and before base station 1-1 and base station 1-2 start communication with a terminal. For example, in a case where the series of processing of S101 to S114 is performed multiple times, the processing may be performed periodically or every time the spatial information varies.

Further, the processing of S101 to S114 mentioned above may be performed by an apparatus other than base station 1-1 and base station 1-2. For instance, in the example of FIG. 5, the processing may be performed by an external apparatus in advance and may be performed by CN2 in the example of FIG. 6.

Processing of S201 to S204 to be described below is performed when communication with a terminal present in an arbitration area is performed, for example. In the following, a description will be given of an example of performing arbitration for coordinated control on a terminal present in an arbitration area corresponding to beam 1(n) of base station 1-1 and beam 2(m) of base station 1-2.

Base station 1-1 receives communication quality information from a terminal (S201). Base station 1-2 receives the communication quality information from the terminal (S202). The communication quality information to be received may be referred to as a measurement report, an MS measurement report, or a US measurement report. The communication quality information may include information on a reception quality of a signal received by the terminal from a base station. For example, the information on the reception quality may be at least one of the following standard specifications: a Reference Signal Received Power (RSRP), a Reference Signal Received Quality (RSRQ), a Received Signal Strength Indicator (RSSI), Channel State Information (CSI), and the like.

A first arbitration is performed (S203). The first arbitration is arbitration based on the information of the reception quality. The first arbitration is performed by base station 1-1, and base station 1-2 may acquire a result from base station 1-1.

A second arbitration is performed (S204). The second arbitration is arbitration based on the result of the first arbitration and the spatial information. The second arbitration is performed by base station 1-1, and base station 1-2 may acquire a result from base station 1-1. Base station 1-1 and base station 1-2 execute the coordinated control based on the result of the second arbitration. For example, when either base station 1-1 or base station 1-2 is selected as the result of the second arbitration, the selected one communicates, by using a beam subject to the arbitration, with a terminal present in the arbitration target area.

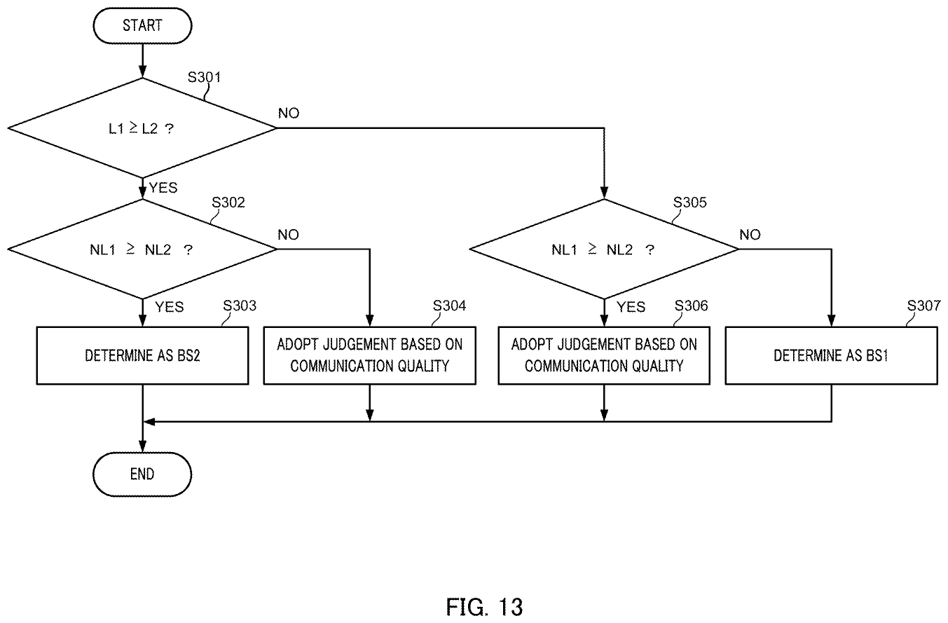

In the above description, a determination example of a rule of the arbitration judgement (arbitration condition) will be described with reference to FIG. 13. FIG. 13 is a flowchart indicating an example of determination of the arbitration condition. For example, the flow illustrated in FIG. 13 may be performed in S111. Further, the flow illustrated in FIG. 13 corresponds to the example illustrated in FIG. 11.

Whether L1 is equal to or greater than L2 is determined (S301). Note that, as in the example illustrated in FIG. 11, the sign L1 indicates the size of path loss in area 1(n) when base station 1-1 transmits a signal using beam 1(n), and the sign L2 indicates the size of path loss in area 2(m) when base station 1-2 transmits a signal using beam 2(m).

When L1 is equal to or greater than L2 (YES in S301), whether NL1 is equal to or greater than NL2 is determined (S302). Note that, as in the example illustrated in FIG. 11, the sign NL1 indicates the size of NLOS in area 1(n) when base station 1-1 transmits a signal using beam 1(n), and the sign NL2 indicates the size of NLOS in area 2(m) when base station 1-2 transmits a signal using beam 2(m).

When NL1 is equal to or greater than NL2 (YES in S302), it is determined, between beam 1(n) of base station 1-1 and beam 2(m) of base station 1-2, that base station 1-2 (“BS2” in FIG. 13) performs communication by using beam 2(m) (S303). The flow illustrated in FIG. 13 then ends.

When NL1 is not equal to or greater than NL2 (NO in S302), it is determined, between beam 1(n) of base station 1-1 and beam 2(m) of base station 1-2, that a base station (and beam) to perform communication adopts the judgement based on the communication quality (i.e., judgement of first arbitration) (S304). The flow illustrated in FIG. 13 then ends.

When L1 is not equal to or greater than L2 (NO in S301), whether NL1 is equal to or greater than NL2 is determined (S305).

When NL1 is equal to or greater than NL2 (YES in S305), it is determined, between beam 1(n) of base station 1-1 and beam 2(m) of base station 1-2, that a base station (and beam) to perform communication adopts the judgement based on the communication quality (i.e., judgement of first arbitration) (S306). The flow illustrated in FIG. 13 then ends.

When NL1 is not equal to or greater than NL2 (NO in S305), it is determined, between beam 1(n) of base station 1-1 and beam 2(m) of base station 1-2, that base station 1-2 (“BS1” in FIG. 13) performs communication by using beam 1(n) (S307). The flow illustrated in FIG. 13 then ends.

When a plurality of pairs of beams forming an arbitration target area is present between beams formed by base station 1-1 and beams formed by base station 1-2, a rule of the arbitration judgement (arbitration condition) may be determined for each pair based on the flow illustrated in FIG. 13.

As described above, in the present embodiment, base station 1 includes controller 13 that controls communication to a terminal cooperating with another base station, based on information on a communication quality between the base station and the terminal and information on a spatial condition that possibly cause a fluctuation in radio wave propagation of a signal to be transmitted to the terminal; and radio communicator 11 that communicates with the terminal under the control of controller 13. With this configuration, even when a report of a communication quality reported from the terminal (may be referred to as MS communication quality report) is low in reliability, an appropriate coordinated control can be performed, thus achieving the coordinated control to improve the communication quality.

Besides, in the present embodiment, a setting (arbitration data) related to coordinated control on communication to a terminal between a plurality of base stations may be configured in advance. This suppresses an increased processing load of a base station.

Further, in the present embodiment, the arbitration data is dynamically or statically configured by a core network. This makes it possible to change the arbitration data even in a case where the spatial information fluctuates or is changed, thus achieving the coordinated control to improve the communication quality.

Here, the case where the spatial information fluctuates may correspond to a case where the spatial information unintentionally varies. For example, the case where the spatial information fluctuates includes at least one of cases of an increase or decrease in a number of structures (e.g., buildings), a change in the weather, and an increase or decrease in traffic. Further, the case where the spatial information is changed may correspond to a case where the spatial information is intentionally changed by a user of the radio communication system (e.g., administrator who performs station placement design). For example, the case where the spatial information is changed includes a case where information on a location of a base station is changed. Incidentally, the case where the spatial information fluctuates or is changed may correspond to a case where the spatial information varies. Further, the case where the spatial information fluctuates or is changed may correspond to a case where a difference (dissimilarity) arises between two pieces of spatial information (e.g., spatial information at different two points in time).

Further, in the present embodiment, the arbitration data is dynamically or statically configured by a base station. This makes it possible to change the arbitration data even in a case where the spatial information fluctuates or is changed, thus achieving the coordinated control to improve the communication quality.

Further, according to the present embodiment, using the spatial information allows to achieve an operation, a specification, and implementation which cannot be covered by the control based on the communication quality. In addition, using the spatial information allows to omit processing for quality measurement in an arbitration algorithm based on the communication quality, thereby reducing a time taken for an initial convergence. Moreover, when the communication quality-based arbitration algorithm and the spatial information are used together in order to learn the arbitration and perform optimization, the convergence accuracy to the optimal solution can be improved.

In the above embodiment, an example has been given in which the spatial information is used for the arbitration for the coordinated control, but the present disclosure is not limited to this.

For example, the spatial information may be used for location estimation of a terminal. In one example, the spatial information may be used to improve the estimation accuracy in the location estimation of the terminal by a Time Of Arrival (TOA) or a Time Difference Of Arrival using a position reference signal (PRS) and/or a reference signal time difference (RSTD).

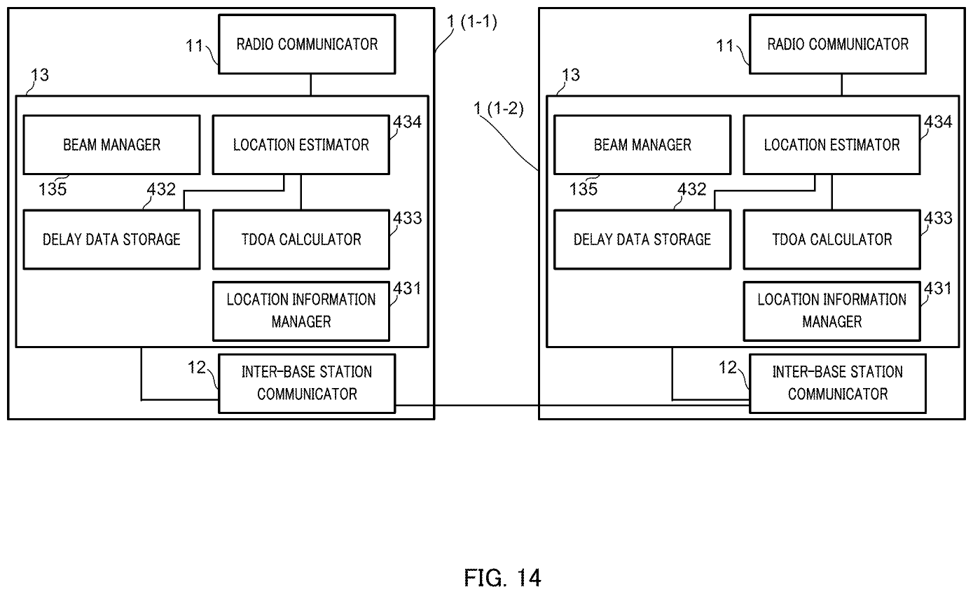

FIG. 14 illustrates a configuration example of a base station that uses the spatial information for the location estimation. In FIG. 14, a configuration for the location estimation is illustrated while a configuration for processing other than the location estimation is omitted. Further, in FIG. 14, the same configurations as in FIG. 4 are given the same reference numerals, and the descriptions thereof are omitted.

Controller 13 of FIG. 14 includes location information manager 431, delay data storage 432, TDOA calculator 433, and location estimator 434.

Location information manager 431 stores and manages location information of a terminal. For example, location information manager 431 stores location information of a terminal that is wirelessly connected to base station 1-1, in association with identification information of the terminal.

Delay data storage 432 stores information on propagation characteristic prediction such as a delay spread determined based on the spatial information.

TDOA calculator 433 calculates TDOA based on a reference signal received from the terminal.

Location estimator 434 corrects, using the delay spread, arrival time (TOA) of the reference signal received from the terminal, and thereby corrects the TDOA. Location estimator 434 estimates a location of the terminal based on the corrected TDOA.

Thus, the correction based on the delay spread calculated with the spatial information improves the estimation accuracy in the location estimation using the corrected arrival time.

In the embodiment described above, the term such as “part” or “portion” or the term ending with a suffix such as “-er” “-or” or “-ar” may be replaced with another term, such as “circuit (circuitry),” “assembly,” “device,” “unit,” or “module.”

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

In addition, in recent years, in Internet of Things (IoT) technology, Cyber Physical Systems (CPS), which is a new concept of creating new added value by information collaboration between physical space and cyberspace, has been attracting attention. Also in the above embodiment, this CPS concept can be adopted.

That is, as a basic configuration of the CPS, for example, an edge server disposed in the physical space and a cloud server disposed in the cyberspace can be connected via a network, and processing can be distributedly performed by processors mounted on both of the servers. Here, it is preferable that processed data generated in the edge server or the cloud server be generated on a standardized platform, and by using such a standardized platform, it is possible to improve efficiency in building a system including various sensor groups and/or IoT application software.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

Although the embodiment has been described above with reference to the drawings, it is needless to say that the present disclosure is not limited to such example. It is apparent to those skilled in the art may arrive at various modifications or variations at within the scope of the claims, and it is naturally understood that they are also within the technical scope of the present disclosure. In addition, any combination of component elements in the above-mentioned embodiment may be made without departure from the spirit of the present disclosure.

While concrete examples of the present disclosure have been described in detail above, these specific examples are mere examples and do not limit the appended claims. The technology described in the appended claims embraces various modifications and changes made in accordance with the specific examples described above.

The disclosure of Japanese Patent Application No. 2021-093740, filed on Jun. 3, 2021, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

1 Base station
2 Core network
11 Radio communicator
12 Inter-base station communicator
13 Controller
21 CU
22 DU
131 Reception quality manager
132 Arbitration data storage
133 First arbitrator
134 Second arbitrator
135 Beam manager
331 Arbitration data generator

1. A base station, comprising:
a controller, which in operation, controls communication to a terminal cooperating with another base station, based on information on a communication quality between the base station and the terminal and information on a spatial condition that possibly causes a fluctuation in radio wave propagation of a signal to be transmitted to the terminal; and
a communicator, which in operation, communicates with the terminal under the control of the controller.

2. The base station according to claim 1, wherein the controller predicts the radio wave propagation between the base station and the terminal by using the information on the spatial condition and controls the communication to the terminal based on a prediction result.

3. The base station according to claim 2, wherein the controller controls the communication to the terminal based on a variation in the information on the spatial condition.

4. The base station according to claim 1, wherein the controller acquires configuration information on the communication to the terminal from an information processing apparatus that predicts the radio wave propagation between the base station and the terminal by using the information on the spatial condition.

5. The base station according to claim 1, wherein configuration information on the communication to the terminal is stored in a storage prior to installation of the base station.

6. The base station according to claim 1, wherein the controller
performs arbitration judgement for the communication to the terminal, based on the communication quality, and
corrects a result of the arbitration judgement, based on the information on the spatial condition.

7. The base station according to claim 1, wherein:
the communicator forms a beam with directivity under directivity control of the controller, and
the controller controls the communication to the terminal, based on information on a beam cooperating with the other base station.

8. The base station according to claim 7, wherein the information on the beam cooperating with the other base station indicates a beam having a geographical area overlapping with that of another beam among a plurality of the beams formed by a plurality of the base stations.

9. The base station according to claim 8, wherein the controller adjusts, based on the information on the spatial condition, power of the beam cooperating with the other base station.

10. The base station according to claim 1, wherein the controller adjusts, based on the information on the spatial condition, a threshold used for determination of whether to coordinate with the other base station.

11. The base station according to claim 1, wherein the controller corrects, based on the information on the spatial condition, information on a distance from the base station to the terminal and estimates a location of the terminal by using the corrected information on the distance.

12. A radio communication method, comprising:
controlling, by a base station, communication to a terminal cooperating with another base station, based on information on a communication quality between the base station and the terminal and information on a spatial condition that possibly causes a fluctuation in radio wave propagation of a signal to be transmitted to the terminal; and
communicating, by the base station, with the terminal under the control of the controller.

13. A radio communication system, comprising:
a first base station;
a second base station; and
a terminal,
wherein
the first base station includes:
a controller, which in operation, controls communication to the terminal cooperating with the second base station, based on information on a communication quality between the first base station and the terminal and information on a spatial condition that possibly causes a fluctuation in radio wave propagation of a signal to be transmitted to the terminal; and
a communicator, which in operation, communicates with the terminal under the control of the controller.
